(19) United States
(12) Patent Application Publication
(10) Pub. No.: US 2020/0078666 A1
(43) Pub. Date: Mar. 12, 2020

(54) LOCATION-BASED MESSAGING SYSTEM

(71) Applicant: Monsarrat, Inc., Cambridge, MA (US)

(72) Inventor: Jonathan MONSARRAT, Cambridge, MA (US)

(21) Appl. No.: 16/612,972

(22) PCT Filed: May 15, 2018
(86) PCT No.: PCT/US2018/032639

§ 371 Date: Nov. 12, 2019

Related U.S. Application Data
(60) Provisional application No. 62/506,820, filed on May 16, 2017.

(51) Int. Cl. A63F 13/216; A63F 13/792; G06Q 30/02; A63F 13/71; A63F 13/30

(52) U.S. Cl. CPC A63F 13/216; A63F 13/792; G06Q 30/0209; A63F 2300/205; A63F 13/30; A63F 2300/69; A63F 2300/535; A63F 13/71

(57) ABSTRACT

In a location-based content delivery system, such as an augmented reality videogame, players are tracked as the move through physical space. Players who match local criteria may be sent messages that offer to play a specific game associated with the destination. When the player accepts the offer, gameplay drives the player to the destination. Staff at the destination may be alerted in advance that a player is arriving, so as to greet the player, or even to play a role in the gameplay. In some aspects, a message throttling protocol is used to prevent a flood of messages when large numbers of players are attracted to a destination.

### CROSS REFERENCE TO RELATED APPLICATIONS

This application claims priority to a U.S. Provisional Patent Application Ser. No. 62/506,820 filed May 16, 2017, the entire contents of which are hereby incorporated by reference.

### BACKGROUND

A virtual environment is one constructed in one or more computer systems; that is to say, an environment which represents a computer simulation of the real world, a simulation of an imaginary world or some combination of the two. A user interacts with or “moves” within the virtual environment by using some input device, such as a mouse, joystick, or in the case of a smartphone, the touchscreen or accelerometers, or other tactile input device. A virtual environment may contain different rooms or locations, through which the user can “walk” by operating various controls. A visual representation of the virtual environment is rendered on an output device, such as a computer monitor or smartphone screen, displaying some aspect of the user's “location” in the virtual world.

Representations of a real world environment may take the form of captured video images, In some cases a combined or overlaid image including the captured real world video and some or all of the graphically rendered virtual environment can be displayed together to present an augmented reality environment. Other representations of the real environment may also be used, such as global positioning system (GPS) information coupled with some knowledge of the real environment (e.g. a map).

Thus in conventional augmented reality systems, a device captures some representation of the real environment (such as a video image, and/or GPS information), and augments that representation with elements of a virtual environment. The virtual elements are related to the real environment either with respect to a detected position of the device (e.g. a GPS signal coupled with a map held within the device), and/or by analysis of captured video images to identify features to which the virtual elements can be related.

These augmented reality platforms are increasingly popular for implementing computer games. Augmented reality brings the engaging play action of video games out the everyday world. One popular example of how engaging these games can be, Pokémon Go, places virtual representations of fictional characters onto a video feed of the real world, enabling the player to interact with the characters and other users at the same time.

### PROBLEMS WITH THE PRIOR ART

These types of massive multiplayer online games (MMPOG) benefit greatly by incorporating a messaging function. It would be especially advantageous if the messaging can be location-based—that is, if communicated content could be presented to a user's mobile device that is relevant to the real world nearby them, such as detected from their GPS coordinates. In one example scenario, these electronic messages can involve a scavenger hunt with directions to send a player to a nearby location.

But because mobile application (“mobile app”) notifications are intrusive, they must be used sparingly to not risk annoying and losing users. If there are a certain number, P, of mobile app users and Q number of nearby location sponsors, there could potentially be P×Q needed notifications. There must be a way to throttle back the number of messages sent, by cleverly choosing whom to send them to.

In a related scenario, we may also want to send messages to trusted individuals. For example, in a scavenger hunt, players may be asked to take photographs of red, blue, and green cars, but the videogame system has no reliable way to judge whether the task has been performed. And we cannot trust the player to self-judge. So we ask the player to find some trusted human, for example a highly rated mobile app user, or a shopkeeper at a retain chain like Walmart that has a business relationship with the provider of the mobile app. Then we ask that trusted human to receive a message and respond, judging the photographs.

But what if the videogame app, which is in the hands of untrusted players, has been hacked? The altered videogame could ask the trusted human a fake question. Or could alter the trusted human's response before sending it to the server. There is a technical security issue of trust to be solved.

An easy fix to the problem would be for the trusted human to have his or her own mobile app, to communicate privately with the videogames server, in a trusted way. This is impractical. We want a solution that works in a trusted way through the untrusted videogame player's untrusted mobile app.

### SUMMARY

The solution to both problems is a method and/or system for location-based messaging within the context of a location-based content distribution system, such as an augmented reality location-based videogame. Some of the objectives and advantages of the approach include:
Using gamification to overcome user's typical negative attitude towards mobile app notifications,
Messages about nearby locations can now incentivize players to visit those locations,
Messages may now offer in-game rewards related to nearby locations,
These rewards may be tied into a videogame competition, so that only winners need be given a reward, and
Messages can now alert a retail store's greeter who is arriving and approximately when.

This type of system would also solve at least the two technical problems described above.

In a first situation, given a set of location-based sponsors and a set of nearby players, the videogame system can use a weighted scoring system to estimate the likelihood of each player to respond to a notification and to physically travel to each location, and to estimate whether that likelihood is likely to go up or down in the next few minutes as the player continues gameplay. That weighted scoring system is then used to only send notification messages to the least difficult players to draw.

In a second environment, we can now provide a secure system by which the trusted videogame system can communicate with a trusted human, through an untrusted player's untrusted mobile app, which may have been hacked. Then these trusted humans add significant value to a location-based videogame, by offering local map knowledge, adjudicating competitions, and otherwise perpetuating gameplay.

Briefly, the techniques described herein assume a location-based content distribution system, such as videogame system with a community of players. The system preferably has access to message targeting information, such as gender, age, and income of the players. As part of gameplay, these players are given a map that has corresponding real-world coordinates, and are asked to move through “map” in the real world. For example, in a Wizard of Oz themed game, a player would first meet the Munchkins in the first physical location, but then travel the Yellow Brick Road meeting many other characters in different locations before eventually getting to Oz.

In one implementation, the characters may be augmented reality characters superimposed as a computer-generated image on the player's view of the real world as a composite view, such as on their mobile device. For the player to get to the fictional location of Oz in the game might just happen to require the user to journey in the real world to a special map location.

In some implementations, the player owns, leases, licenses, or otherwise pays another person or entity for access to the videogame in which the techniques described herein are implemented. This other person (or entity) may agree for the player to receive message notifications in exchange for a lower gameplay cost or free play. As part of the agreement, this person gives permission for message targeting that may include:
Discovering keywords in their communications with other players;
Requiring them to answer specific lead qualifying questions;
Requiring them to create a personal profile with message targeting parameters;
Allowing gameplay metrics to be tracked, for example whether a player is willing to travel more than a mile for gameplay, or whether this person tends to play aggressively.

A real world destination that wishes to engage with nearby players may have a web-based management portal through which he or she can set up messages, manage them, and see performance metrics, configuring:
The content of the messages;
The target attributes that restrict which players are shown messages;
The times, target locations, and limited time offers of messages to be run;
Pricing caps and bids;
Rewards, including potentially cash or coupons;
System integration with the local destination's own data processing system

The messaging system may continually query the user community database to find inactive players who may be offered a fresh game at a sponsor location, or active players whose gameplay may be rerouted to have them arrive a sponsor location.

These person people are then offered a gameplay experience, which may be tied to an explicit reward. Competing with other players may comprise part of winning a reward.

Players who accept are routed to the sponsor location and given the appropriate reward. This may include passing them to the sponsor's data processing system to issue a reward such as a coupon. This may also include alerting the arrival of the potential customer to retail employees, so that they can participate in the gameplay as part of the gamification that may lead to a buy.

The system could give statistics on gameplay experiences that are offered and responded to, which could be potentially integrated with the sponsor's data processing system.

Just as a retailer may send employees out onto the sidewalk to hold a sign or hand out samples to passersby, retailers may even send staff out of the store to the surrounding area to directly interact with players as part of gameplay, hoping to draw them to the retail location.

The resulting technical challenges are then:
a) How can message targeting attributes be assigned to players?
b) What is the best way to share messages with potential relevant recipients?
c) What is the best way to choose which players to send notifications to?
d) What is the best way for a local destination to offer a reward for players to visit?
e) What is the best way for trusted humans to answer videogame questions through a player's mobile app that may have been hacked?

These problems are solved with a method and system according to a preferred embodiment in the following way:
a) Message targeting may done via:
   active players' location, or inactive players' location, direction of movement, and typical locations of activity;
   keywords found in player-to-player conversations;
   the player's user profile criteria, e.g. geography, industry, job types and titles, company size;
   the player's gameplay statistics, e.g. how far they are willing to travel for a given reward or gameplay experience; or
   identifying players to a sponsor's data processing system that makes its own picks
b) An inactive player may be presented with a gameplay opportunity through their videogame, which may be time-limited in duration, and which may offer a specific reward, which need not be labeled as sponsored. An active player has already agreed to partake in a gameplay experience and would simply be routed to a particular location, such as a sponsored location, perhaps with a new reward added. The videogame may then communicate the challenges of the game, the list of competing players if any, and the map location where players are to go for play.
c) Message traffic may be limited—that is, players may be shown only the messages that they are likely to respond to, based on a calculation including:
   a match of the targetable attributes set by the local destination for this message;
   the location of the player;
   the price the local destination is willing to pay
   the likelihood of the player to accept the gameplay experience, based on the distance to travel, reward, and history of the player; and/or
   a maximum frequency that messages are sent to a given player;
d) Players who play and arrive at the local destination may be rewarded:
   Not at all, except for the fun of gameplay;
   With game points or other in-game rewards, which may be calculated to appeal to the player's in-game needs and goals;
   A coupon redeemable by entering the local destination;
   Cash as a payment made through the videogame system
e) A local destination may place a bid specifying how much it's worth to them to attract a player to physically come to their location. These bids then play a role in determining which players get shown messages. These bids may be preset, or the system may send real-time alerts to the local destination when players are nearby, and the local destination may respond with a customized bid, for example with a higher reward to fill empty seats in a restaurant.
f) The trusted human has a custom printed piece of paper (or an entire pad of paper slip), with the paper having:
   A bar code to identify the trusted human holding the slip of paper
   A coded way to verify the questions from the videogame server through the untrusted player's videogame app,
   And a coded way to verify the answers given by the trusted through the untrusted player's videogame app to the videogame server.
These coded verifications are done by self-referential communications and a modified checksum and distress code.

### BRIEF DESCRIPTION OF THE DRAWINGS

The foregoing and other features, and advantages will be apparent from the following more particular description of preferred embodiments, as illustrated in the accompanying drawings in which like reference characters refer to the same parts throughout the different views.

FIG. 1 shows a system for secure communication to a trusted human through an untrusted player and untrusted videogame mobile app.

FIG. 2 shows how a local destination sets up a location-based game message.

FIG. 3 shows how players are matched with locations, and the game plays out.

FIG. 4 shows an example of gameplay.

FIG. 5 shows an example of message metrics reported to a local destination.

FIG. 6 shows an example data schema for the system.

FIG. 7 shows how to throttle down the number of notifications sent to players.

### DETAILED DESCRIPTION OF PREFERRED EMBODIMENTS

A description of preferred embodiments follows.

### Trusted Communications Through an Untrusted Videogame Mobile App

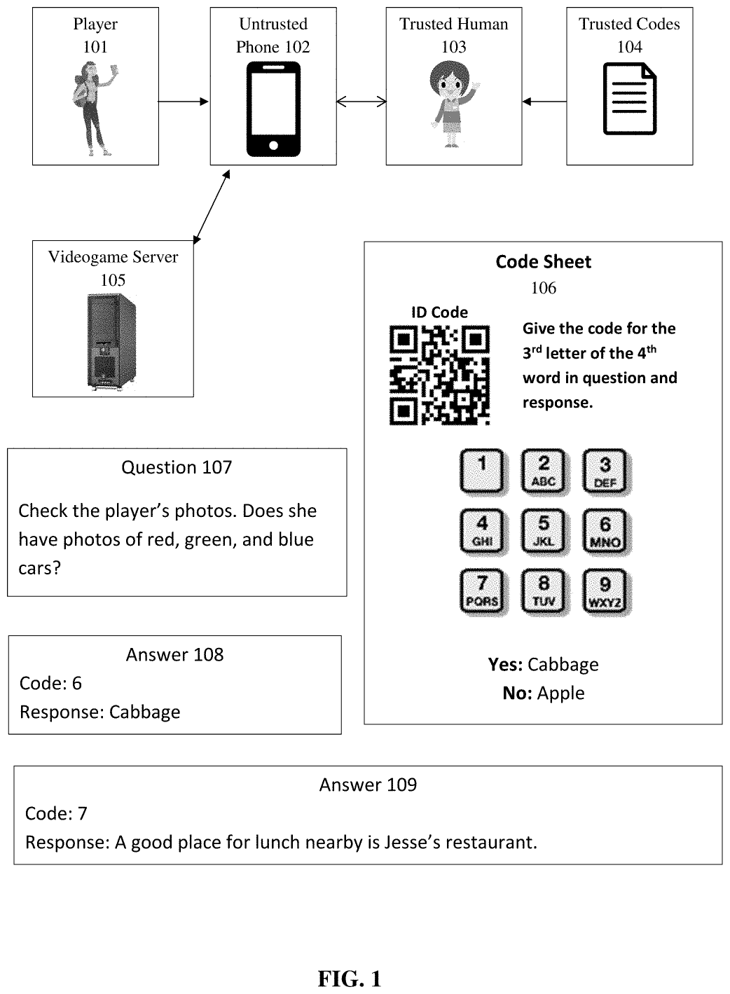

FIG. 1 shows how we can add trusted human intelligence to a videogame app, even if the player and app are untrusted, and without the trusted human needing his or her own mobile app or Internet connection.

Player 101 has an Untrusted Phone 102 with a version of the videogame that could easily have been hacked. She is sent by the videogame to a retail location, for example, Walmart, and meets the Trusted Human 103. This person is trusted because the maker of the videogame has a commercial relationship with the retail chain.

In this example, Player 101 has been asked to run a scavenger hunt, taking photos of red, blue, and green automobiles nearby. Player 101 hands her Untrusted Phone 102 to Trusted Human 103. The Videogame Server 105 sends a question to the phone for the trusted staff to view. It asks Question 107, “Check the player's photos. Does she have photos of red, green, and blue cars?” The Trusted Human 103 may simply respond, “Yes” by clicking a yes button on Untrusted Phone 102 and handing it back to Player 101.

Unfortunately, if Untrusted Phone 102 has a version of the videogame app that has been hacked, the malicious app could change the question. Although the Videogame Server 105 asks Question 107, the question that is actually displayed to the Trusted Human 103 would be “Do you like flowers”? The answer is bound to be yes. Or, if the correct question is displayed and the Trusted Human 103 responds, “No”, the malicious app could change it to a “Yes” before sending that response to the Videogame Server 105. This is a problem.

We do not wish to require Trusted Human 103 to install the videogame mobile app, which is a complication. We also do not want to force Trusted Human 103 to perform a checksum on the questions and responses given. That is too much mathematics. Instead, we instead use a sheet of Trusted Codes 104. The videogame sends these Trusted Codes 104 to the Trusted Human 103 via ground mail, email, or other method in advance, when the trust relationship is established.

First, Player 101 hands her Untrusted Phone 102 to the Trusted Human 103. She scans in the QR code on the Code Sheet 106. This identifies to the Videogame Server 105 which Trusted Human 103 and Code Sheet 106 we are dealing with. A check of the GPS on Untrusted Phone 102 can confirm that the Player 101 really is standing at the correct retail location for Code Sheet 106, or the code sheets may be intended for one-time use only, with the retail manager given a pad of code sheets.

The Videogame Server 105 sends Question 107 to the Untrusted Phone 102 where it is read by the Trusted Human 103. She then verifies the question in a way that a malicious app cannot predict, by selecting a letter and verifying that letter in code. In this case, Code Sheet 106 tells Trusted Human 103 to confirm the 3^{rd} letter of the 4^{th} word. The 4^{th} word in Question 107 is “photos” with the third letter being “o”. That is number 6 on the keypad shown on Code Sheet 106. Of course, the keypad could present an arbitrary mapping of letters to numbers or letters, but a keypad is easy and familiar, good enough to catch cheats.

Then, instead of responding yes or no, the Trusted Human 103 replies with Answer 101 that gives code words for Yes and No, Cabbage or Apple, as shown on Code Sheet 106. This is similar to a duress code/password system employed by spies. Of course, if Trusted Human 103 chooses to give a longer answer, such as Answer 109, she again validates this answer giving code 7, because the 3^{rd} letter of the 4^{th} word is “R”, which is code 7.

In these examples, a maliciously hacked videogames app has no way of knowing that “Cabbage” is a good answer and “Apple” is a bad answer, or that “6” and “7” indicate valid questions and answers. So there is no way for a malicious app to fake these coded responses.

### A Local Destination Sets Up Messaging Parameters

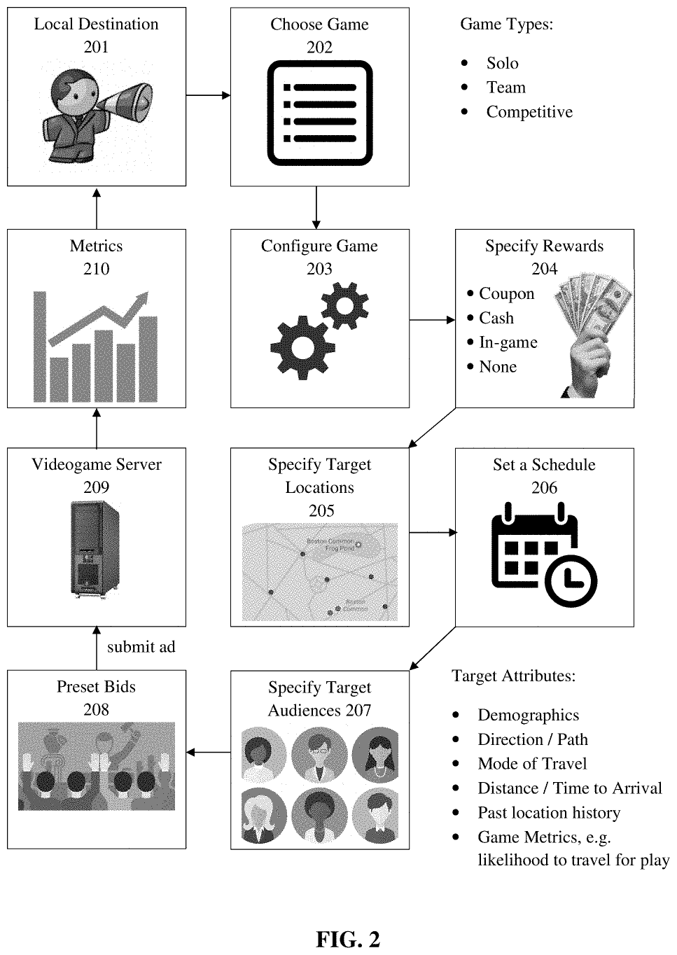

FIG. 2 shows one example of how a local destination uses a mobile device or personal computer to contact the videogame server to configure how the sending of to nearby players should be controlled.

Through a web browser interface, the Local Destination 201 either uploads a custom game experience or Chooses a Game 202 from a list of pre-built experiences, which may be designed for a single player, for cooperative team play, or for competition between two or more players.

Then he or she Configures the Game 203, using an HTML form through a mobile device or personal computer. For example, if the game is a trivia game, the Local Destination 201 may be given text boxes to type in the questions and answers. Or the game may allow the Local Destination 201 to upload video, images to be used in the game, such as their logo, or to select a color theme, 3D character, or other parameter used in gameplay. The game may also be partly autogenerated using local map information, such as a scavenger hunt to take a photo of (as seen by an algorithm in the map metadata) a nearby museum and bus stop. This configuration information is stored on an Videogame Server 209.

Next the Local Destination 201 continues through the web browser on his or her mobile device or personal computer to Specify Rewards 204 for winners (and even losers) of the game. These may be:
No reward at all,
An in-game reward, such as:
   A new battleaxe that gets given to the player in the game,
   An official status as Mayor for A Day at the sponsor location,
   In-game points or in-game financial units (“Monopoly Money”)
A cash reward to be distributed through the videogame onto the player's credit card, or
An cash reward in coupon form that may be used at a sponsor location, presumably the location associated with the message.

In the case of an in-game reward, the Local Destination 201 may need to purchase these rewards from the gamemaker, but they would be chosen as something the player desires more than the comparable amount in cash.

Next the Local Destination 201 uses his or her mobile device or personal computer to Specify Target Locations 205 for the message. These locations may be named and stored separately for future reference. Point locations may be indicated by:
Uploading a list of destination names and addresses
Individually typing in a destination name and address
Clicking on a map

Regional locations may also be selected when a local destination wants to draw tourists to a large area with many entrances, such as a mall, stadium, or beach.

The Local Destination 201 then Sets a Schedule 206 for the message, the dates and times that the messages will be presented to users. Options may include:
Limiting gameplay to automatically calculated daytime hours between local sunrise and sunset,
Limiting gameplay to when many users are online, for team play, or
Excluding business hours or limiting play to weekends.

The Local Destination 201 then Specifies one or more Target Audiences 207 for the message, defining the types of potential player that should be shown the message. Attributes could include demographics and user profile information, which are typical for online messaging systems, but most importantly here, also includes location-based game attributes and real-time conditions such as:
Whether the player is heading towards the sponsored location already,
Whether the player's path has been pre-set and is heading in the correct direction,
Whether the player is in a region that statistically has had people willing to travel to the sponsor location,
The mode of travel of the player, based on a speed assessment and GPS tracking (subway, highway, bicycle, walking, jogging),
The distance in miles to arrive at the promoted location,
The estimated time to arrive at the promoted location,
Statistically how likely the player has been in the past to respond to a message at this distance, or
Game metrics, such as:
   Is this a power user who values an in-game reward, for example has taken on the most challenging tasks in the past or is looking for a rare in-game item to complete a collection?
   Is this someone athletic who might be willing to run?
   Does this player like to play solo or with others?
   Has this player been flagged by other players for especially good or poor sportsmanship?

Finally, the Local Destination 201 assigns a bid with each Specified Target Audience 207, which is the highest amount that the Local Destination 201 is willing to pay to attract a player matching the target criteria to one of the Target Locations 205.

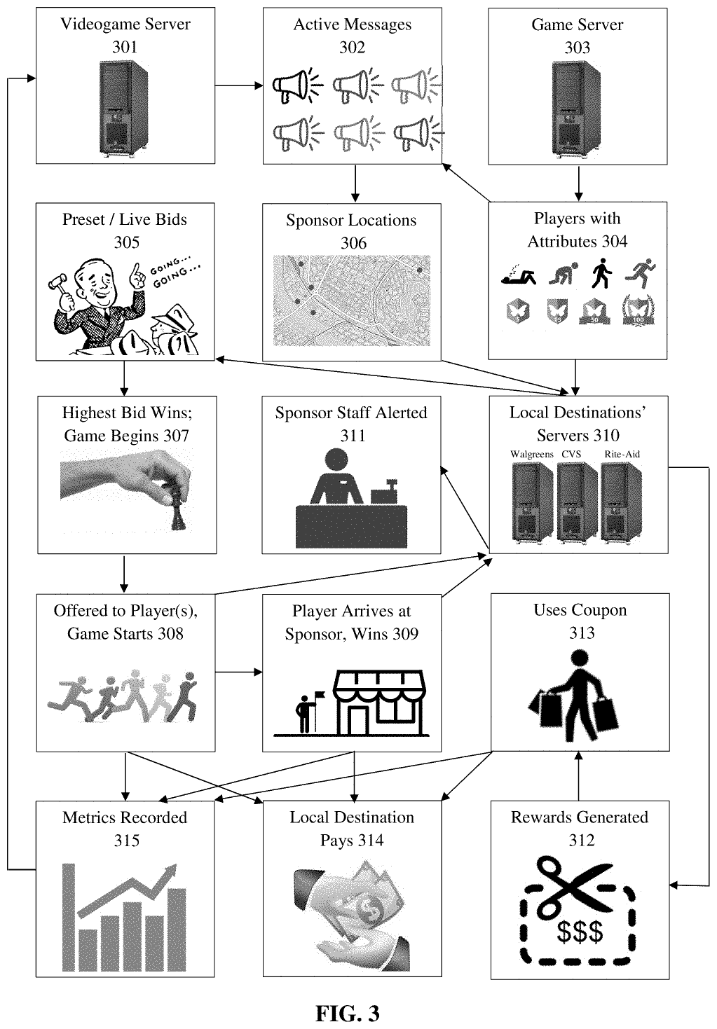

From the Local Destination 201 personal computer or mobile device, the Local Destination 201 has then completed the construction of the message, and submits it to this invention's Videogame Server 209. As messages are delivered (see FIG. 3), Metrics 210 are computed and reported to the Local Destination 201. A more detailed discussion of possible metrics is provided below.

### A Message is Chosen and Displayed to a Player, Who Plays

FIG. 3 shows how a message is chosen to present to a player's mobile device, and how that gameplay runs.

The Videogame Server 301 contains potentially several Active Messages 302 from a variety of local destinations. The Game Server 303 fetches from the database information about Players with Attributes 304 that can be targeted by local destinations as shown in FIG. 2. These player attributes are matched against the targeting criteria of the Active Messages 302 and the Sponsor Locations 306 of these messages. One example targeting criteria may be—“Are there Players 304 who are close enough to a Sponsored Location 306 that they may be sent a sponsored game invitation 309”?

In some cases, the target players will be idle, not playing the game, though with their phones set to receive alerts. In some cases, the players will already be halfway through participating in an adventure. For example, in the Wizard of Oz, a player may first meet the Munchkins and the Tin Man before being chosen for a potential message. From there they could be routed in any direction to find the Scarecrow, Lion, and Emerald City. They might as well be routed to a local destination. Once a player has started a game it is unlikely that they will quit, which makes them a much safer bet for a high bid from a local destination.

When matching players are found on the Local Destination's Server 310, their information is sent in real-time to the Servers of Multiple Local Destinations 310 so that a real-time bid can be made. In this case the Local Destination Servers 310 are for the competitive pharmacies Walgreens, CVS, and Rite-Aid. If the game associated with the message is meant for more than one player, then more than one player is sent.

These Local Destination Servers 310 assess the potential and submit a Live Bid 305, or the system defaults to a Preset Bid 305. The local destination who makes the Highest Bid Wins 307 access to the player, who is sent the game invitation.

If the player abandons the game or stops playing, then no further action is needed by the system. However, the player may also click to say “choose another direction” if the algorithm is sending the player the wrong way that they want to be headed. In this case, the second highest bidder may have its sponsored game presented to the player, if its location is in the right direction.

In this example, a single player accepts and the Game Begins 308. As part of location-based gameplay, the player uses their mobile device and moves through the real-world, and eventually the Player Arrives at the Sponsor Location 309 and potentially wins a reward 309. Even a player who loses a competition may get a consolation prize.

The reward given to a player may be preset, or a request can be made to the Local Destination Server 310 to have a Reward Generated 312 in real-time. For example, a restaurant who unexpectedly has empty tables may give a higher reward to draw in a customer than at other times of the day. The player Uses the Coupon 313 (or other reward) that can be exchanged for something of value. The coupon or reward, for example, may be presented to the user as part of making a purchase, making the local destination happy. The coupon may be presented through a Point of Sale system operated at the Sponsor Location 309, for an immediate reward to the player, or saved for later use in an on-line e-commerce transaction, or in other ways.

Also, the Local Destination May Pay 314 at other stages of gameplay:
When the Game is Offered to the Player 308, even if the game is refused, which is like a Web message that is displayed, counting as an “impression”,
When the Player Accepts the Game 308, even if it is never completed, which is like a Web message that is clicked on.
When the Player Arrives at the Sponsor Location 309, even if they do not go in, or if it is not known whether they go in, which is like a Web message that gets clicked and leads to some browsing of the website behind the message, or
When a Player Uses a Coupon 313 as part of a purchase, which is like a Web message that is clicked and eventually leads to something being purchased in its online store.

Of course, Metrics are Recorded 315 at every stage of gameplay and recoded in the Videogame Server 301.

### Example of Gameplay

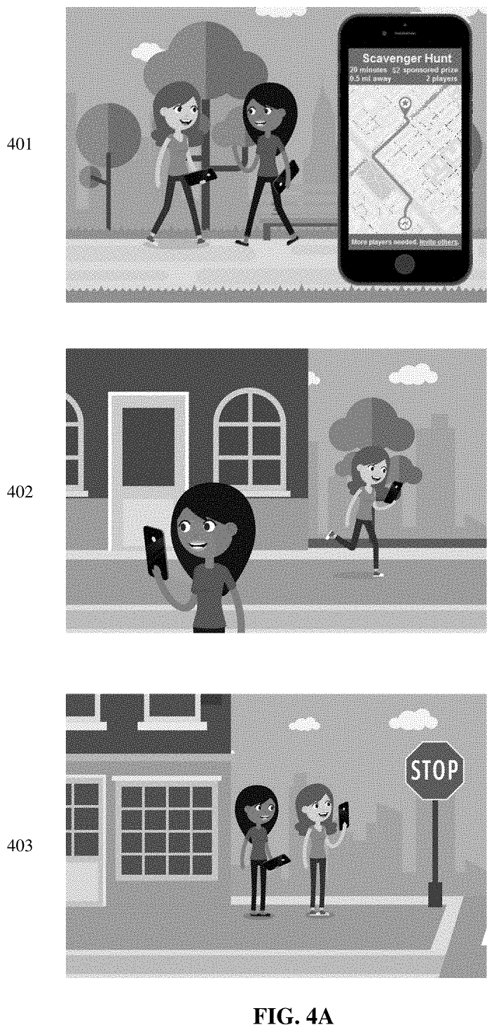

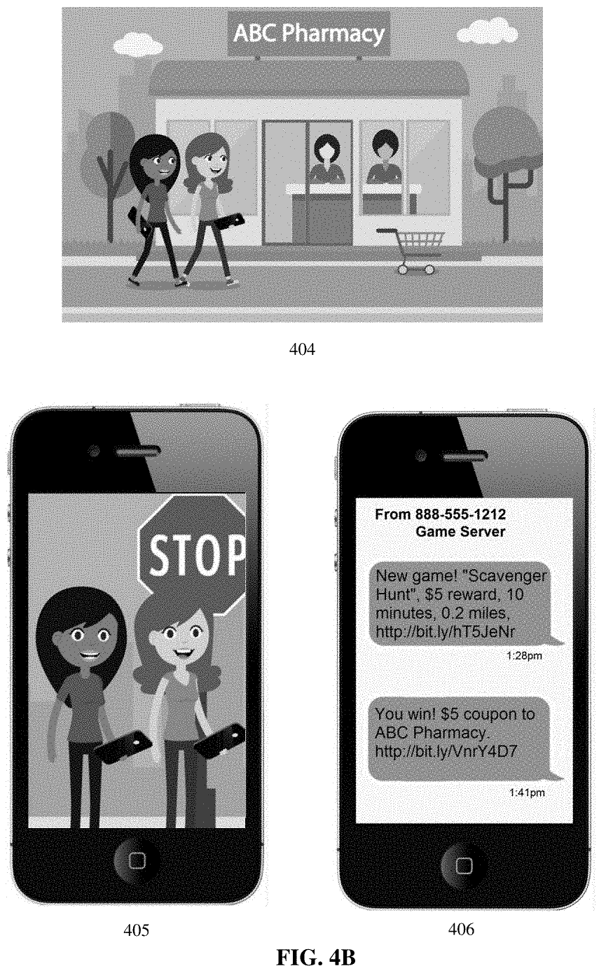

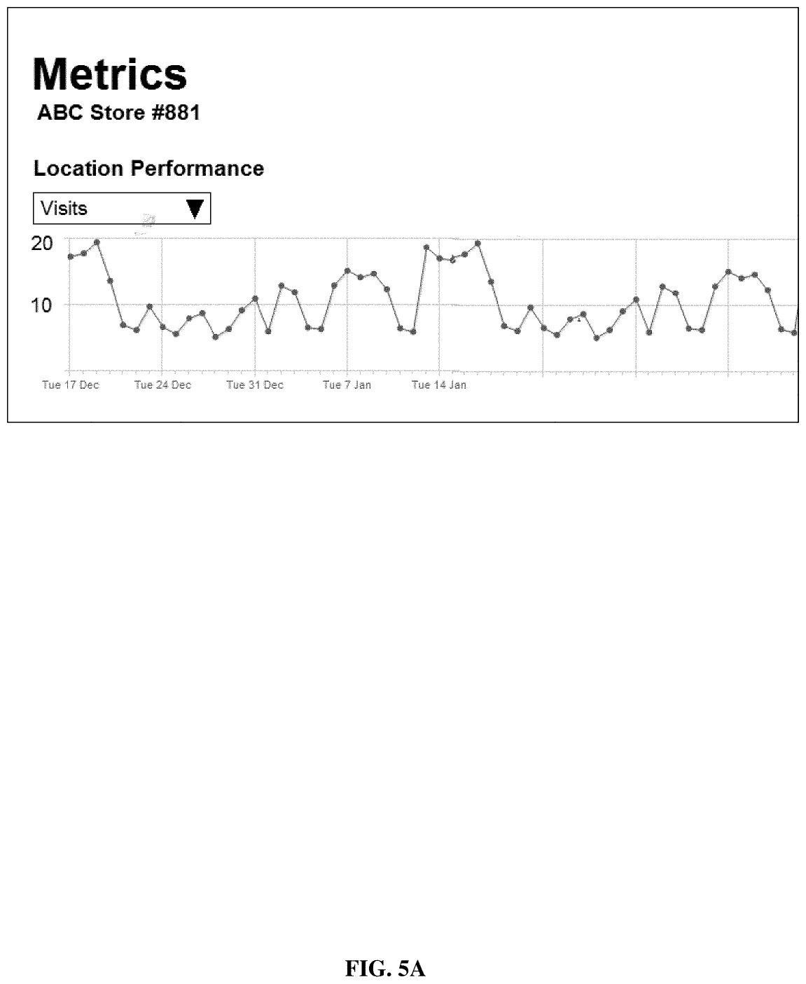

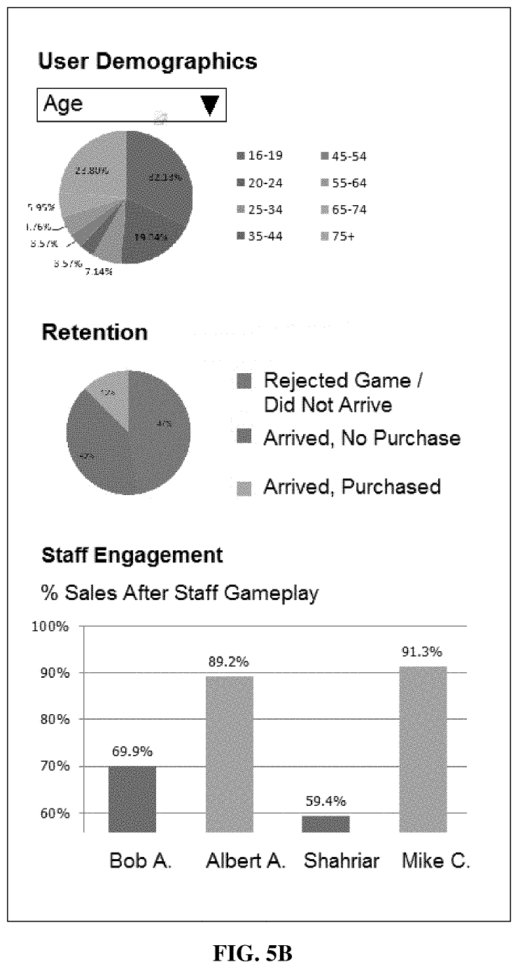

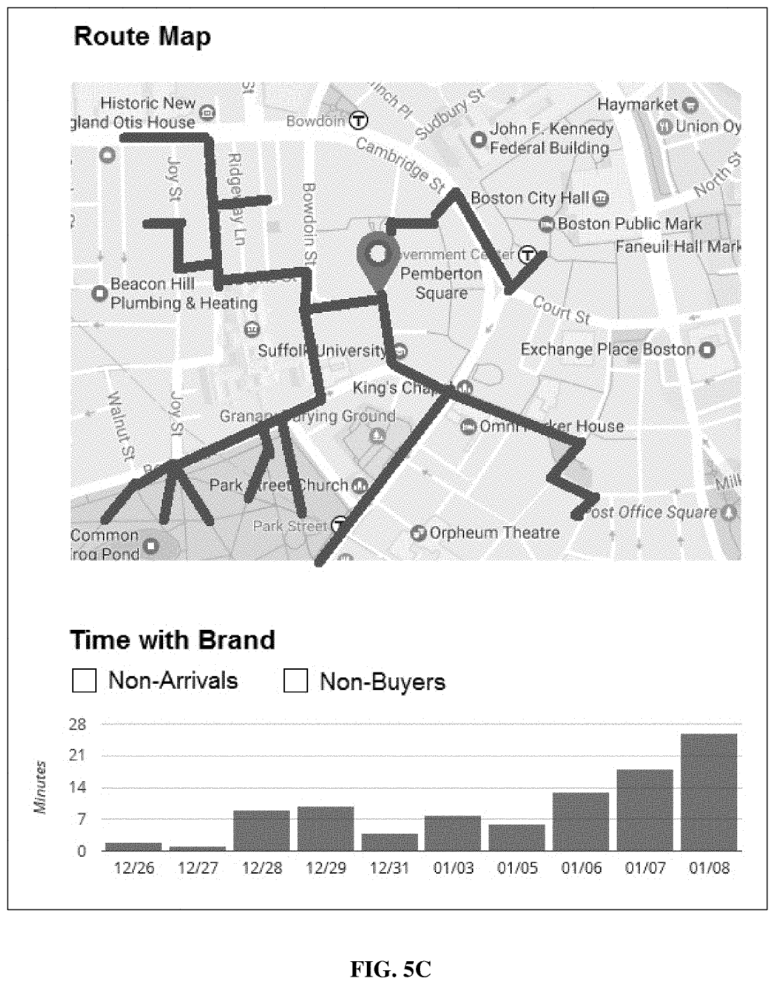

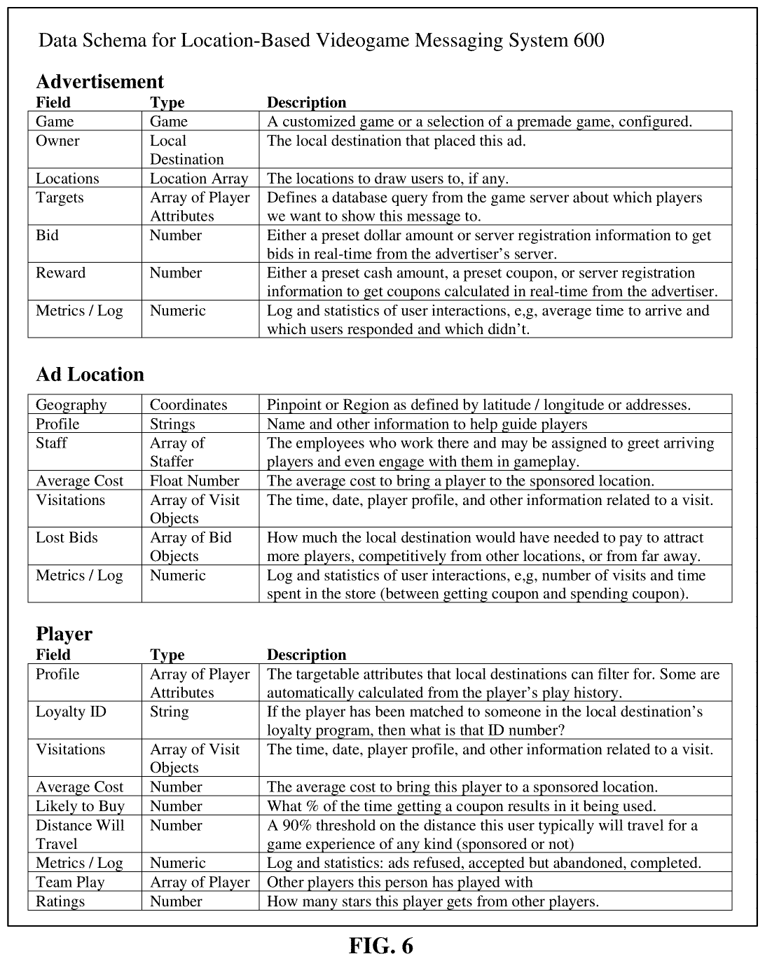

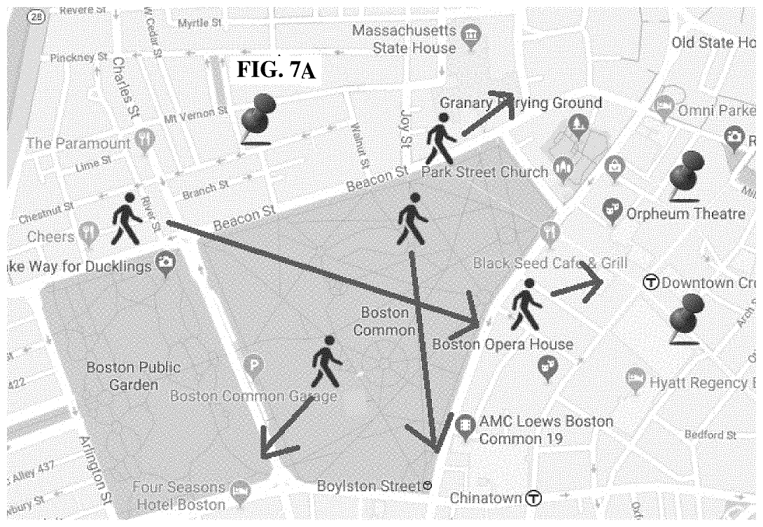

FIG. 4 shows an example of collaborative team gameplay.

A game sponsored by ABC Pharmacy is presented to Ashley and Carla 401, who either know each other and are currently collocated, or who don't know each other, but choose to meet.

The game presented is a Scavenger Hunt 401, which promises a 20-minute experience with only a 0.5 mile walk, and $2 sponsored prize if successfully completed.

The scavenger hunt has been automatically generated from map metadata. For example, the game system notices that in-between the players and the sponsored destination are a stop sign, a school, a statue, and an Indian restaurant. To play the scavenger hunt, Carla and Ashley must run around 402 looking for these map features, and take a photo as proof that they found them. For example, they find a stop sign and take a selfie with it 403.

Eventually Carla and Ashley have taken photos of everything on the scavenger hunt and head towards the final destination, ABC Pharmacy, which is the sponsored location of this message game. As they approach, an alert is sent to the local destination's servers or via text message to let Connor, a store employee of ABC Pharmacy 404, know that players are arriving.

When Carla and Ashley arrive 404, Connor at ABC Pharmacy is ready for them. “Hello, Carla and Ashley!” he says. “You have bravely taken on the scavenger hunt challenge. What did you find?”

There are many types of game that can be adjudicated by computer, such as a trivia game, but in this case, only a human can confirm that Ashley and Carla really did take a selfie with the stop sign 405. Connor confirms their photos and gives them a reward, which in this case is sent to Ashley's and Carla's phones via text message 406.

Ashley and Carla has a great time. They love ABC Pharmacy and feel a sense of accomplishment to have “earned” the $2 discount. They will be sure to buy many products and to tell their friends!

### Metrics on Sponsored Game Performance

Naturally, local destinations will want to know how well their sponsored games are performing to spread brand recognition, draw customers, and stimulate sales. On this example page are shown:
The performance of Location ABC Store #881 over time, in this case how many daily visits by players were made from December as % of players who buy, average amount spent, and how much reward per mile is required to draw a player.
A Route Map that shows the routes that players traveled to arrive at the sponsored location
User demographics such as age, which may also include the targetable game attributes from FIG. 2.
How much time the player spend with the sponsored brand, which may be everpresent in gameplay, en route to the sponsored location.
Optionally, staff at the sponsored location may be tasked to greet players, engage in gameplay with them or judge their success, and guide them towards making a purchase. Statistics could be shown of each individual staffer's success in getting player to make a purchase. Perhaps the more theatrically inclined retail employees will have an edge in getting the players to have so much fun in the game that of course they spend money, or at least leave with greater good will for the brand and a willingness to spread word of mouth.

### Throttling Back Notifications

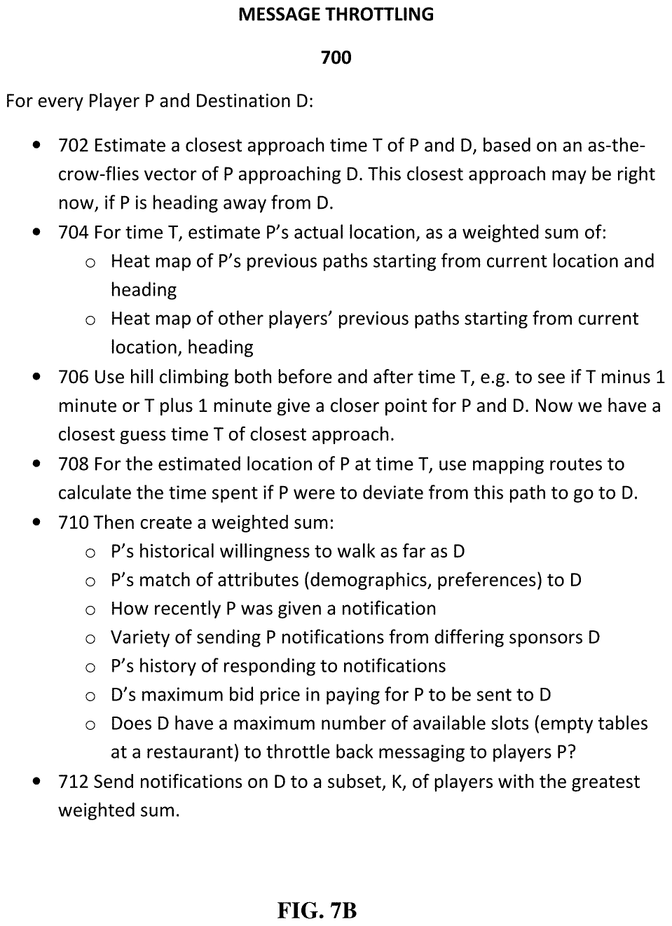

In some scenarios, a popular virtual environment such as a massively parallel on-line game like Pokemon Go might have many 1000's or 10,000's of players active near a specific location, such as in a large city. There may also be 100's or even 1000's of locations that may each be vying for the attention of the many players. FIG. 7 shows a process for how notifications from the servers 301 or 303 (see FIG. 3) can be throttled back to support a large combination of players and sponsor destinations without overwhelming either the server side or flooding the individual mobile devices with too many messages.

Starting at step 7001, for every combination of player P and destination D, we proceed to step 702 and first estimate, at what future point will the player be closest to that destination? If the player is heading on a vector away from D, then that time might be right now, since every future minute would just place P farther from D.

We may begin with an estimate, taking the as-the-crow-flies vector of P and finding the closest point along that path to D. Based on the player's current speed we can then estimate an approximate future time T when P may be closest to D.

However, maps create detours, roadblocks, and hindrances to straight as-the-crow-flies travel. So at 704 we find a more accurate estimate of P's location, using a heat map of historical information. Where historically has P traveled to, given this current starting place and approximate vector? Where historically have other users traveled to, given P's current position and vector? A weighted superposition gives the answer of where P should be located at time T.

Then, at 706, we use a hill-climbing function to check the minutes before T and the minutes after T whether, using actual map pathways, some other time T′ would actually be the closest approach of P to D.

From this, at 708 we can calculate P's inconvenience in detouring off route to visit D. This gets plugged into a weighted sum that estimates P's willingness to deviate, P's likelihood of a match to destination D given P's demographics, profile keywords, and responding to notifications. For example, if P is a dedicated player with a history of following game quests, and who wants to score an accomplishment, P may be willing to travel farther.

Next a weighted sum can be determined at 710. In the weighted scoring, we must account for how recently P has received a notification and whether P has received too many recent notifications from a single sponsor (a lack of variety).

We should also account for whether destination D has limited capacity. If D is a restaurant with a single empty table, we mustn't invite 100 players to all come to D.

Finally, we may optionally into account bidding information. How much is D willing to pay for P to come running? Then we compare that to the cost of drawing P, based on P's inconvenience, likelihood of responding, the risk of losing P as a player due to annoying notifications, and the future lifetime value of keeping P as a player.

The subset, K, of all players P, and destinations D with the most optimal weighted scores are the ones that actually get sent notifications to their mobile devices at step 712, at the future time T when they are likely to be closest.

What is claimed is:

1. A method of interaction between two or more portable electronic devices and a system wherein each device comprises one or more physical positioning system devices, the method comprising the steps of:
at one or more servers:
defining a coordinate system common to the portable electronic devices with respect to a physically defined reference location;
receiving an estimate of the physical position of each portable electronic device;
generating a virtual environment that defines a map in which the virtual environment is shared in common between the portable electronic devices;
maintaining position data of the portable electronic devices within the map responsive to the estimates of its physical position;
forwarding information to the portable electronic devices to enable a view of the shared virtual environment responsive to its respective position on the map;
identifying a user who may be idle or already active within the virtual environment;
sending one or more prompt messages to prompt the user to move to a new destination on the map;
sending one or more routing messages that provide instructions for routing the user to the new destination; and
controlling how many of the prompt or routing messages are sent to a portable electronic device depending upon at least the estimate of physical position at least one other factor that depends on the user of the portable electronic device.

2. The method as in claim 1 further comprising:
in response to the user following the routing messages, accepting a payment from an entity associated with the new destination.

3. The method of claim 1 wherein the virtual environment is a videogame and the users are players of the videogame.

4. The method of claim 3 further comprising:
allowing one or more local destinations to generate prompt messages that target specific players based on targetable attributes known to the videogame.

5. The method of claim 4 further compromising:
providing identifying information about players to another data processing system associated with the one or more local destinations.

6. The method of claim 3 further comprising:
automatically determining targetable attributes based on a player's gameplay history.

7. The method of claim 1 further comprising:
in response to the user actually arriving at the new destination, offering a reward to the user.

8. The method of claim 7, wherein the virtual environment is a videogame and the users are players, further comprising:
offering competitive gameplay to multiple ones of the players who receive a different or no reward based on an outcome of the competitive gameplay.

9. The method of claim 3 further comprising:
allowing payments to be made when:
a player is offered a sponsored game;
a player arrives at the sponsored location;
a player spends a specific amount of time at the sponsored location; or
a player spends a coupon given as a reward for gameplay.

10. The method of claim 3 further comprising:
accepting bids from one or more local destinations that are further used to determine which players are sent to which local destination.

11. The method of claim 1 further comprising:
providing an API interface for a messaging system to communicate in real-time with a local destination's data processing system to offer to the local destination a nearby player, and receive from the local destination a real-time bid on this player.

12. The method as in claim 1 further comprising:
providing an API interface for a messaging system to communicate in real-time with a local destination's data processing system to allow local destinations to add, configure, and remove messages in the system in real-time.

13. The method as in claim 1 further comprising:
providing an API interface for a messaging system to communicate in real-time with a local destination's data processing system to signal to a local destination when a player is expected to arrive at a sponsored location.

14. The method as in claim 1 further comprising:
providing an API interface for a messaging system to communicate in real-time with a local destination's data processing system, to request that a proposed reward for gameplay be generated by the local destination's own data processing system, so that this reward may be presented to a player with the offer to play the sponsored game;

15. The method as in claim 3 further comprising:
analyzing keywords in conversations between players to compute targetable attributes.

16. The method as in claim 2 further comprising:
computing messaging metrics and presenting them to data processing systems associated with one or more local destinations.

17. The method as in claim 10 further comprising:
sending an alert message to local destination staff that relates to the about the location of inbound players, so that these staff may:
greet players and ask for lead qualifying information or loyalty cards;
play with arriving players;
adjudicate gameplay of arriving players;
puppet game characters or otherwise administrate gameplay;
manually rate players for fair gameplay; or
manually update the targetable attributes of players;

18. The method as in claim 3 further comprising:
providing an interface on the player's mobile device, such that when the player is offered a sponsored game, the player may reject it because the player does not wish to travel in that direction, and in that case, sending another routing message proposing instead a different location as the gameplay destination.

19. The method as in claim 1 further comprising:
further controlling how many of the prompt or destination messages are sent to attract each of many players to each of many destinations.

20. The method as in claim 3 further comprising:
where the player is an untrusted player and the videogame is an untrusted videogame mobile app,
enabling communication between a trusted human and a videogame server that is trusted, without requiring a private channel from the trusted human to the videogame server.

What is claimed is:

1. A method of interaction between two or more portable electronic devices and
a system wherein each device comprises one or more physical positioning system devices, the method comprising the steps of:
at one or more servers:
defining a coordinate system common to the portable electronic devices with respect to a physically defined reference location;
receiving an estimate of the physical position of each portable electronic device;
generating a virtual environment that defines a map in which the virtual environment is shared in common between the portable electronic devices;
maintaining position data of the portable electronic devices within the map responsive to the estimates of its physical position;
forwarding information to the portable electronic devices to enable a view of the shared virtual environment responsive to its respective position on the map;
identifying a user who may be idle or already active within the virtual environment;
sending one or more prompt messages to prompt the user to move to a new destination on the map;
sending one or more routing messages that provide instructions for routing the user to the new destination; and
controlling how many of the prompt or routing messages are sent to a portable electronic device depending upon at least the estimate of physical position at least one other factor that depends on the user of the portable electronic device.

2. The method as in claim 1 further comprising:
in response to the user following the routing messages, accepting a payment from an entity associated with the new destination.

3. The method of claim 1 wherein the virtual environment is a videogame and the users are players of the videogame.

4. The method of claim 3 further comprising:
allowing one or more local destinations to generate prompt messages that target specific players based on targetable attributes known to the videogame.

5. The method of claim 4 further compromising:
providing identifying information about players to another data processing system associated with the one or more local destinations.

6. The method of claim 3 further comprising:
automatically determining targetable attributes based on a player's gameplay history.

7. The method of claim 1 further comprising:
in response to the user actually arriving at the new destination, offering a reward to the user.

8. The method of claim 7, wherein the virtual environment is a videogame and the users are players, further comprising:
offering competitive gameplay to multiple ones of the players who receive a different or no reward based on an outcome of the competitive gameplay.

9. The method of claim 3 further comprising:
allowing payments to be made when:
a player is offered a sponsored game;
a player arrives at the sponsored location;
a player spends a specific amount of time at the sponsored location; or
a player spends a coupon given as a reward for gameplay.

10. The method of claim 3 further comprising:
accepting bids from one or more local destinations that are further used to determine which players are sent to which local destination.

11. The method of claim 1 further comprising:
providing an API interface for a messaging system to communicate in real-time with a local destination's data processing system to offer to the local destination a nearby player, and receive from the local destination a real-time bid on this player.

12. The method as in claim 1 further comprising:
providing an API interface for a messaging system to communicate in real-time with a local destination's data processing system to allow local destinations to add, configure, and remove messages in the system in real-time.

13. The method as in claim 1 further comprising:
providing an API interface for a messaging system to communicate in real-time with a local destination's data processing system to signal to a local destination when a player is expected to arrive at a sponsored location.

14. The method as in claim 1 further comprising:
providing an API interface for a messaging system to communicate in real-time with a local destination's data processing system, to request that a proposed reward for gameplay be generated by the local destination's own data processing system, so that this reward may be presented to a player with the offer to play the sponsored game;

15. The method as in claim 3 further comprising:
analyzing keywords in conversations between players to compute targetable attributes.

16. The method as in claim 2 further comprising:
computing messaging metrics and presenting them to data processing systems associated with one or more local destinations.

17. The method as in claim 10 further comprising:
sending an alert message to local destination staff that relates to the about the location of inbound players, so that these staff may:
greet players and ask for lead qualifying information or loyalty cards;
play with arriving players;
adjudicate gameplay of arriving players;
puppet game characters or otherwise administrate gameplay;
manually rate players for fair gameplay; or
manually update the targetable attributes of players;

18. The method as in claim 3 further comprising:
providing an interface on the player's mobile device, such that when the player is offered a sponsored game, the player may reject it because the player does not wish to travel in that direction, and in that case, sending another routing message proposing instead a different location as the gameplay destination.

19. The method as in claim 1 further comprising:
further controlling how many of the prompt or destination messages are sent to attract each of many players to each of many destinations.

20. The method as in claim 3 further comprising:
where the player is an untrusted player and the videogame is an untrusted videogame mobile app,
enabling communication between a trusted human and a videogame server that is trusted, without requiring a private channel from the trusted human to the videogame server.
